(19) United States
(12) Patent Application Publication
(10) Pub. No.: US 2017/0202729 A1
(43) Pub. Date: Jul. 20, 2017

(54) FOAM ROLLER

(71) Applicant: MENG CHIEN LIN, Taichung City (TW)

(72) Inventor: MENG CHIEN LIN, Taichung City (TW)

(21) Appl. No.: 15/168,028

(22) Filed: May 28, 2016

(30) Foreign Application Priority Data
Jan. 14, 2016 (TW) 105200489

(51) Int. Cl. A61H 15/00

(52) U.S. Cl. CPC A61H 15/0092; A61H 2015/0014

(57) ABSTRACT

A foam roller includes a cylindrical body having a passage defined axially therethrough. A support coat made of multiple foam portions includes more than two different colors, and the foam portions are connected to each other by way of heat-pressing. The foam portions are coated to the outer surface of the body and have a first face and a second face. At least the second face has multiple continuous grooves and multiple continuous protrusions, wherein the outer face of each of the protrusions is removed by way of cutting or grinding so as to form a processed face. The processed face and the grooves located on two sides of the processed face have three different colors.

### BACKGROUND OF THE INVENTION

1. Fields of the Invention

The present invention relates to a foam roller, and more particularly, to a foam roller with multiple colored foams.

2. Descriptions of Related Art

The conventional foam rollers are designed to promotes deep tissue massage and instant relief from tight muscles, and generally comprise a cylindrical body with multiple grooves and protrusions on the outer surface of the body. However, the existed foam rollers are mostly made to have only one color which is boring to the users after a period of time of use. Most users do not purchase multiple foam rollers simply because of different colors. Besides the expenses, the storage space is another problem when having multiple foam rollers at home.

The present invention intends to provide a foam roller which includes multiple colors to eliminate the shortcomings mentioned above.

### SUMMARY OF THE INVENTION

The present invention relates to a foam roller and comprises a cylindrical body and a passage is defined axially through the body. A support coat made of multiple foam portions includes more than two different colors, and the foam portions are connected to each other by way of heat-pressing. The foam portions are coated to the outer surface of the body and have a first face and a second face. At least the second face has multiple continuous grooves and multiple continuous protrusions, wherein the outer face of each of the protrusions is removed by way of cutting or grinding so as to form a processed face. The processed face and the grooves located on two sides of the processed face have three different colors.

The primary object of the present invention is to provide a foam roller that has multiple colors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the foam roller of the present invention;

FIG. 2 is a cross sectional view of a portion of the foam roller of the present invention;

FIG. 3 is a cross sectional view to show the processed faces are formed;

FIG. 4 is an exploded view to show the support coat of the second embodiment of the foam roller of the present invention, and

FIG. 5 is a cross sectional view of the support coat of the second embodiment of the foam roller of the present invention.

### DETAILED DESCRIPTION OF THE PREFERRED EMBODIMENT

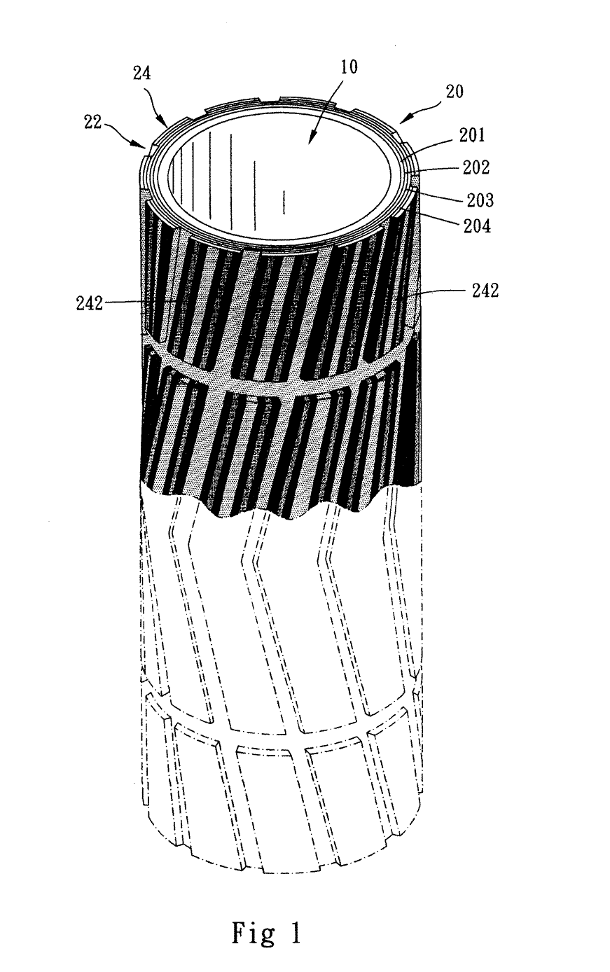

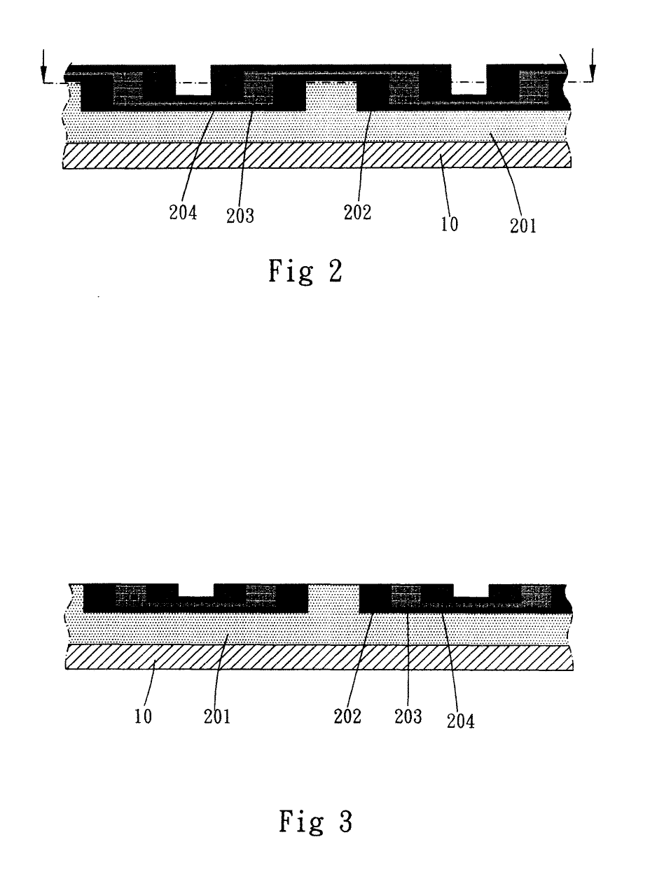

Referring to FIGS. 1 to 3, the foam roller of the present invention comprises a body 10 which is a cylindrical body and has a passage 12 defined axially therethrough. The body 10 has an inner surface and an outer surface. A support coat 20 made of multiple foam portions which is connected to the outer surface of the body 10. The support coat 20 includes more than two different colors. The foam portions are connected to each other by way of heat-pressing. The foam portions is connected to the outer surface of the body 10 and has a first face and a second face. Specifically, the underside of the support coat 20 is connected to the outer surface of the body 10 by glue.

At least the second face has multiple continuous grooves 22 and multiple continuous protrusions 24. The outer face of each of the protrusions 24 is removed completely or partially, by way of cutting or grinding so as to form a processed face 242, wherein the processed face 242 and the grooves 22 located on two sides of the processed face 242 have three different colors. The support coat 20 has a proper softness so as to provide comfort to the users.

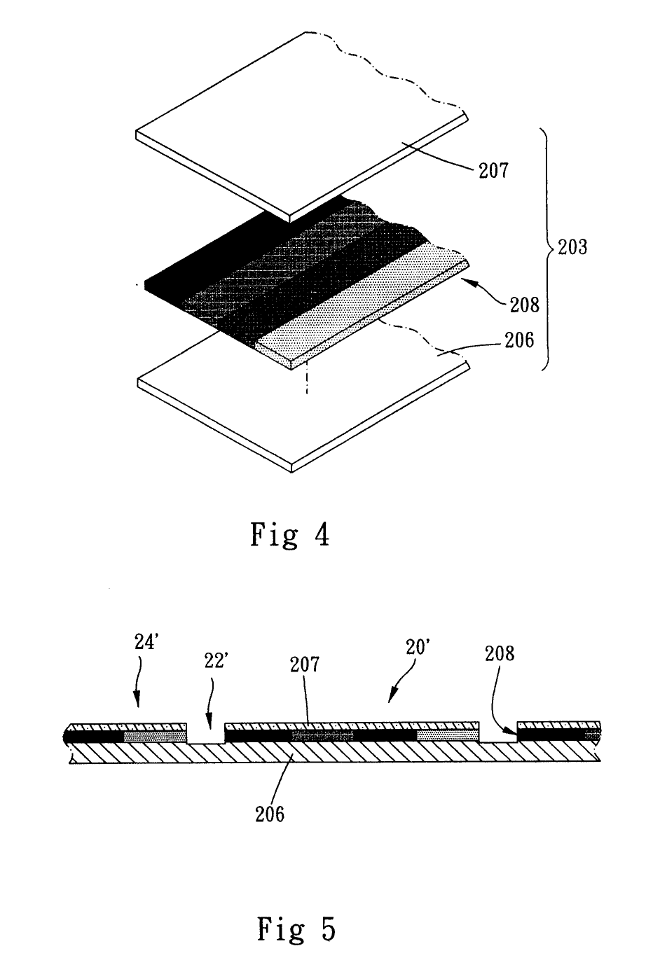

FIGS. 4 to 5, the second embodiment of the foam roller of the present invention comprises a cylindrical body 10 which has a passage 12 defined axially therethrough. The body 10 has an inner surface and an outer surface.

A support coat 20′ has a first axis and a second axis which is shorter than the first axis. The support coat 20′ has a bottom foam layer 206, a top foam layer 207 and a mediate foam layer 208, wherein the mediate foam layer 208 has multiple elongate foam members with more than two different colors. The elongate foam members are arranged along the first axis or the second axis. The bottom foam layer 206, the top foam layer 207 and the mediate foam layer 208 are connected to each other by way of heat-pressing. The support coat 20′ is coated to the outer surface of the body 10 and has a first face and a second face. The underside of the support coat 20′ is connected to the outer surface of the body 10 by glue. At least the second face has multiple continuous grooves 22′ and multiple continuous protrusions 24′. The outer face of each of the protrusions 24′ is removed by way of cutting or grinding so as to form a processed face 242. The processed face 242 has more than two different colors. One of the bottom foam layer 206 and the top foam layer 207, or both of the bottom foam layer 206 and the top foam layer 207 are made by the multiple elongate foam members of the mediate foam layer 208.

While we have shown and described the embodiment in accordance with the present invention, it should be clear to those skilled in the art that further embodiments may be made without departing from the scope of the present invention.

What is claimed is:

1. A foam roller comprising:
a body being a cylindrical body and having a passage defined axially therethrough, the body having an inner surface and an outer surface, and
a support coat made of multiple foam portions which includes more than two different colors, the foam portions being connected to each other by way of heat-pressing, the foam portions coated to the outer surface of the body and having a first face and a second face, at least the second face having multiple continuous grooves and multiple continuous protrusions, an outer face of each of the protrusions being removed by way of cutting or grinding so as to form a processed face, the processed face and the grooves located on two sides of the processed face having three different colors.

2. The foam roller as claimed in claim 1, wherein an underside of the support coat is connected to the outer surface of the body by glue.

3. A foam roller comprising:
a body being a cylindrical body and having a passage defined axially therethrough, the body having an inner surface and an outer surface, and
a support coat having a first axis and a second axis which is shorter than the first axis, the support coat having a bottom foam layer, a top foam layer and a mediate foam layer, the mediate foam layer having multiple elongate foam members with more than two different colors, the elongate foam members arranged along the first axis or the second axis, the bottom foam layer, the top foam layer and the mediate foam layer being connected to each other by way of heat-pressing, the support coat being coated to the outer surface of the body and having a first face and a second face, at least the second face having multiple continuous grooves and multiple continuous protrusions, an outer face of each of the protrusions being removed by way of cutting or grinding so as to form a processed face, the processed face having more than two different colors.

4. The foam roller as claimed in claim 3, wherein one of the bottom foam layer and the top foam layer, or both of the bottom foam layer and the top foam layer are made by the multiple elongate foam members of the mediate foam layer.
